(19) United States
(12) Patent Application Publication
(10) Pub. No.: US 2022/0385421 A1
(43) Pub. Date: Dec. 1, 2022

(54) SIGNAL GENERATION DEVICE AND EQUALIZATION PROCESSING DEVICE

(71) Applicant: FUJITSU LIMITED, Kawasaki-shi (JP)

(72) Inventors: Xiaofei SU, Beijing (CN); Zhenning TAO, Beijing (CN); Tong YE, Beijing (CN)

(73) Assignee: FUJITSU LIMITED, Kawasaki-shi (JP)

(21) Appl. No.: 17/730,678

(22) Filed: Apr. 27, 2022

(30) Foreign Application Priority Data
May 31, 2021 (CN) 202110601495.3

(51) Int. Cl. H04L 5/00; H04L 27/08

(52) U.S. Cl. CPC H04L 5/0048; H04L 5/0044; H04L 27/08

(57) ABSTRACT

This disclosure provides a signal generation device and an equalization processing device. The signal generation device generates a pilot sequence and payload, the pilot sequence and the payload having identical or similar amplitude probability characteristics. Hence, nonlinear interference may be resisted, and performance of the communication system may be improved.

### CROSS-REFERENCE TO RELATED APPLICATIONS

This application claims priority under 35 USC 119 to Chinese patent application no. 202110601495.3, filed on May 31, 2021, in the China National Intellectual Property Administration, the entire contents of which are incorporated herein by reference.

### TECHNICAL FIELD

This disclosure relates to the field of communication technologies.

### BACKGROUND

Optical communication systems occupy an important position in communication transmission networks for their advantages of huge transmission bandwidths, extremely low transmission losses and low costs. In order to further increase communication capacities, a scheme of high baud rate and high-order modulation scheme is widely used in optical communication systems.

In the scheme of high baud rate and high-order modulation format, nonlinear distortion of electrical devices and optoelectronic devices has become an important factor limiting a performance of a system. In addition to a performance penalty caused by nonlinear distortion itself, it also interferes with normal operations of linear equalization, resulting in further degradation of the performance of the system. Therefore, accurate linear equalization for an optical communication system with nonlinear distortion becomes a key to improve the performance of the optical communication system.

There are already some adaptive equalization schemes for high baud rate and high-order modulation formats, such as a constant-modulus algorithm (CMA) in Literature [1], a least-mean square (LMS) error algorithm in Literature [2], and a decision-directed least-mean square (DD-LMS) error algorithm in Literature [3].

Literature [1]: C R Johnson, P. Schniter, T J Endres, J D Behm, D R Brown, and R A Casas, “Blind equalization using the constant modulus criterion: A review,” Proc. IEEE, vol. 86, no. 10, pp. 1927-1950, October 1998.

Literature [2]: Savory S J, Gavioli G, Killey R I, et al. Transmission of 42.8 Gbit/s Polarization Multiplexed NRZ-QPSK over 6400 km of Standard Fiber with no Optical Dispersion Compensation. IEEE, 2007.

Literature [3]: Winzer P J, Gnauck A H, Doerr C R, et al. Spectrally Efficient Long-Haul Optical Networking Using 112-Gb/s Polarization-Multiplexed 16-QAM [J]. Journal of Lightwave Technology, 2010, 28(4): 547-556.

It should be noted that the above description of the background art is merely provided for clear and complete explanation of this disclosure and for easy understanding by those skilled in the art. And it should not be understood that the above technical solution is known to those skilled in the art as it is described in the background art of this disclosure.

### SUMMARY

It was found by the inventors that with respect to resistance of nonlinear effect, there exists no appropriate adaptive equalization method currently.

An existing pilot sequence is usually QPSK (quadrature phase shift keying) mapped pilot sequence, a receiver relies on the pilot sequence to perform adaptive equalization (AEQ), and an algorithm of the AEQ may be the above-described CMA, LMS or DD-LMS. Therefore, payloads with different modulation formats may be adaptively equalized with identical pilot sequences, and a pair of transceivers may process payloads with multiple modulation formats. Under a linear condition, an optimal equalizer obtained for this pilot sequence is also optimal for the payloads.

An amplitude of the pilot sequence may be selected as an amplitude to which average power of the payloads correspond, or may also be selected as a maximum amplitude on a constellation diagram of the payloads. Conventional QPSK pilot sequence has single amplitude.

A nonlinear effect is related to an amplitude characteristic of a signal. Under a nonlinear condition, as payloads and pilot sequence have different amplitude characteristics, the above adaptive equalization using pilot sequence with a single amplitude will be difficult in resisting the nonlinear effect of the payloads.

Embodiments of this disclosure provide a signal generation device and an equalization processing device, in which pilot sequence and payload generated by the signal generation device have identical or similar amplitude probability characteristics. Therefore, it may be ensured that under a nonlinear condition, adaptive equalization performed based on the pilot sequence may also be applicable to the payloads, and no nonlinear penalty will be introduced.

According to a first aspect of the embodiments of this disclosure, there is provided a signal generation device, generating pilot sequence and payloads, the pilot sequence and the payload having identical or similar amplitude probability characteristics.

According to a second aspect of the embodiments of this disclosure, there is provided a signal generation device, generating pilot sequence and payloads, wherein a ratio of a difference between a gain amount of the pilot sequence and a gain amount of the payload to the gain amount of the payload is less than a preset value.

According to a third aspect of the embodiments of this disclosure, there is provided an equalization processing device, performing adaptive equalization processing based on pilot sequence, wherein the pilot sequence and the payload have identical or similar amplitude probability characteristics, or a ratio of a difference between a gain amount of the pilot sequence and a gain amount of the payload to the gain amount of the payload is less than a preset value.

An advantage of the embodiments of this disclosure exists in that the pilot sequence and payload generated by the signal generation device have identical or similar amplitude probability characteristics. Therefore, it may be ensured that under a nonlinear condition, adaptive equalization performed based on the pilot sequence may also be applicable to the payloads, and no nonlinear penalty will be introduced.

With reference to the following description and drawings, the particular embodiments of this disclosure are disclosed in detail, and the principle of this disclosure and the manners of use are indicated. It should be understood that the scope of the embodiments of this disclosure is not limited thereto. The embodiments of this disclosure contain many alternations, modifications and equivalents within the scope of the terms of the appended claims.

Features that are described and/or illustrated with respect to one embodiment may be used in the same way or in a similar way in one or more other embodiments and/or in combination with or instead of the features of the other embodiments.

It should be emphasized that the term “comprises/comprising/includes/including” when used in this specification is taken to specify the presence of stated features, integers, steps or components but does not preclude the presence or addition of one or more other features, integers, steps, components or groups thereof.

### BRIEF DESCRIPTION OF THE DRAWINGS

Many aspects of the disclosure can be better understood with reference to the following drawings. The components in the drawings are not necessarily to scale, emphasis instead being placed upon clearly illustrating the principles of the present disclosure. To facilitate illustrating and describing some parts of the disclosure, corresponding portions of the drawings may be exaggerated or reduced in size. Elements and features depicted in one drawing or embodiment of the disclosure may be combined with elements and features depicted in one or more additional drawings or embodiments. Moreover, in the drawings, like reference numerals designate corresponding parts throughout the several views and may be used to designate like or similar parts in more than one embodiment.

In the drawings:

FIG. 1 is schematic diagram of a communication system including the signal generation device of Embodiment 1;

FIG. 2 is a schematic diagram of a constellation diagram and amplitude probability density distribution diagram of payload of 64 QAM;

FIG. 3 is a schematic diagram of a constellation diagram of a pilot sequence of Embodiment 1;

FIG. 4 is another schematic diagram of the constellation diagram of the pilot sequence of Embodiment 1;

FIG. 5 is a schematic diagram of a system Q value of a CMA scheme to which the pilot sequence of Implementation 1 corresponds;

FIG. 6 is a schematic diagram of a constellation diagram of a pilot sequence of Implementation 2;

FIG. 7 is a schematic diagram of a system Q value of a CMA scheme to which the pilot sequence of Implementation 2 corresponds;

FIG. 8 is a schematic diagram of a constellation diagram of a pilot sequence of Implementation 3;

FIG. 9 is another schematic diagram of the constellation diagram of the pilot sequence of Implementation 3;

FIG. 10 is a diagram of a relationship between a gain amount difference and a system Q value in a single amplitude pilot sequence scheme;

FIG. 11 is a schematic diagram of the signal generation method of Embodiment 2;

FIG. 12 is a schematic diagram of the equalization processing method of Embodiment 2;

FIG. 13 is a schematic diagram of a systematic structure of the electronic device of Embodiment 3;

FIG. 14 is a schematic diagram of a systematic structure of the transmitter of Embodiment 3; and

FIG. 15 is a schematic diagram of a systematic structure of the receiver of Embodiment 3.

### DETAILED DESCRIPTION OF THE DISCLOSURE

These and further aspects and features of the present disclosure will be apparent with reference to the following description and attached drawings. These embodiments are exemplary only, and are not intended to limit this disclosure. In order to enable those skilled in the art to easily understand principles and implementations of this disclosure, the embodiments of this disclosure shall be described by taking reconstructed images of image compression processing as an example. However, it should be understood that the embodiments of this disclosure is not limited thereto, and other reconstructed images based on other image processing are also covered by the scope of this disclosure.

In the embodiments of this disclosure, terms “first”, and “second”, etc., are used to differentiate different elements with respect to names, and do not indicate spatial arrangement or temporal orders of these elements, and these elements should not be limited by these terms. Terms “and/or” include any one and all combinations of one or more relevantly listed terms. Terms “contain”, “include” and “have” refer to existence of stated features, elements, components, or assemblies, but do not exclude existence or addition of one or more other features, elements, components, or assemblies.

In the embodiments of this disclosure, single forms “a”, and “the”, etc., include plural forms, and should be understood as “a kind of” or “a type of” in a broad sense, but should not defined as a meaning of “one”; and the term “the” should be understood as including both a single form and a plural form, except specified otherwise. Furthermore, the term “according to” should be understood as “at least partially according to”, the term “based on” should be understood as “at least partially based on”, except specified otherwise.

Embodiments of this disclosure shall be described below with reference to the accompanying drawings.

### EMBODIMENT 1

The embodiment of this disclosure provides a signal generation device.

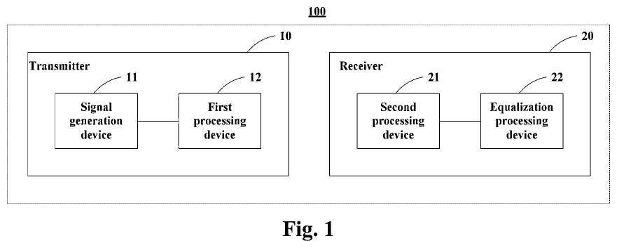

FIG. 1 is schematic diagram of a communication system including the signal generation device of Embodiment 1. As shown in FIG. 1, the communication system 100 may include a transmitter 10 and receiver 20.

The transmitter 10 may include a signal generation device 11 and a first processing device 12. The signal generation device 11 may output a generated pilot sequence and payloads to the first processing device 12, and the first processing device 12 performs first processing on the pilot sequence and the payloads, the first processing being, for example, digital-to-analog conversion, radio frequency amplification, and modulation, etc. The pilot sequence and the payloads after the first processing are transmitted from a transmitter end of the transmitter 10.

The receiver 20 may include a second processing device 21 and an equalization processing device 22. The second processing device 21 performs second processing on a received signal, the second processing being, for example, optical hybrid, photoelectric conversion, and analog-to-digital conversion, etc. With the second processing, the pilot sequence and the payloads may be obtained from the received signal.

The first processing device 12 and the second processing device 21 may include an electrical input and electrical output device, such as a radio frequency amplifier, etc., and may also include an optical input and electrical output device, such as an optical coherent receiver with transimpedance amplifier, input of which being optical signals, and output of which being electrical signals; however, the embodiments of this disclosure are not limited thereto.

Nonlinearity may exist in the payloads obtained by the equalization processing device 22. Such nonlinearity may be brought about by nonlinearity of at least one of a communication link between the transmitter 10 and the receiver 20, the first processing device 12 and the second processing device 21.

The equalization processing device 22 may perform adaptive equalization processing based on the obtained pilot sequence and payload. Since the pilot sequence generated by the signal generation device 11 of this disclosure is specifically designed, an adaptive equalizer obtained by the equalization processing device 22 through the adaptive equalization processing may resist an influence of a nonlinear effect on the payloads.

Next, the pilot sequence generated by the signal generation device 11 shall be described.

In the description of this disclosure, a modulation format of the payloads is, for example, 64 QAM (quadrature amplitude modulation).

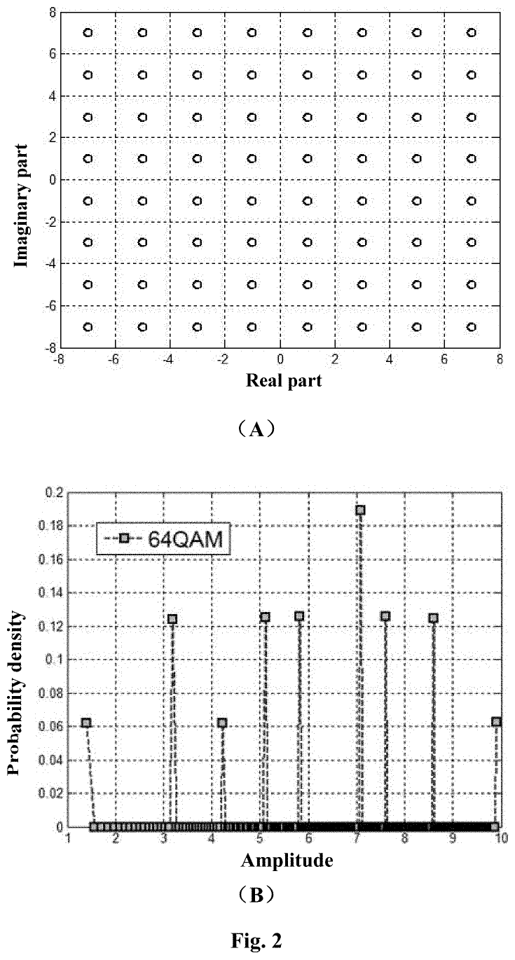

FIG. 2 is a schematic diagram of a constellation diagram and amplitude probability density distribution diagram of payload of 64 QAM. (A) of FIG. 2 is a constellation diagram of payload of 64 QAM, in which the horizontal axis denotes a real part and the vertical axis denotes an imaginary part. (B) of FIG. 2 is a diagram of amplitude probability density distribution of the payload of 64 QAM. The horizontal axis denotes amplitude and the vertical axis denotes a probability density. As shown in FIG. 2, the payload of 64 QAM have 9 amplitude selections.

In this embodiment, the pilot sequence and the payloads have identical or similar amplitude probability characteristics. The amplitude probability characteristics may be expressed as probability density distribution or as origin moments. There exists a definite correlation between a probability feature function, a probability mother function and a moment mother function, and the probability feature function and probability density distribution are a Fourier transform pair and there exists a one-to-one correspondence therebetween. Although a probability density function is taken as an example in the following description, similar descriptions are also applicable to embodiments where a probability feature function, a probability mother function and a moment mother function are taken as examples.

In this embodiment, the pilot sequence may be inserted into the payload, and there is no limitation on an insertion ratio of the pilot sequence and an insertion position of the pilot sequence in the payload.

In this embodiment, an overall average value of the pilot sequences is zero, and the distribution of the pilot sequences is symmetrical in four quadrants.

In this embodiment, the signal generation device 11 may detect the amplitude probability characteristic of the payload, or the amplitude probability characteristic of the payload is known, hence, the signal generation device 11 may generate and transmit pilot sequences with amplitude probability characteristics identical or similar to those of the payloads.

This embodiment shall be described below by way of implementations 1-5.

Implementation 1:

In Implementation 1, amplitude selection of the pilot sequence is identical to amplitude selection of the payload, and each amplitude selection of the pilot sequence corresponds to 4 constellation points, phases of the 4 constellation points making that the 4 constellation points are rotationally symmetrical relative to the origin of the constellation diagram by 90 degrees. That is, the pilot sequence has an amplitude probability characteristic identical to that of the payload.

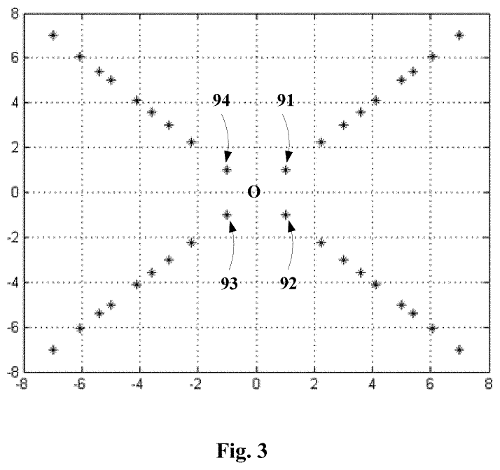

FIG. 3 is a schematic diagram of the constellation diagram of the pilot sequence of Implementation 1. As shown in FIG. 3, the pilot sequence may have 9 amplitude selections, which may be identical to the 9 amplitude selections shown in (B) of FIG. 2, respectively. Each amplitude selection corresponds to 4 constellation points; for example, constellation points 91, 92, 93 and 94 in FIG. 3 correspond to the same amplitude selection, and phases of the 4 constellation points 91, 92, 93 and 94 are such that the 4 constellation points 91, 92, 93 and 94 are rotationally symmetrical relative to the origin O of the constellation diagram by 90 degrees.

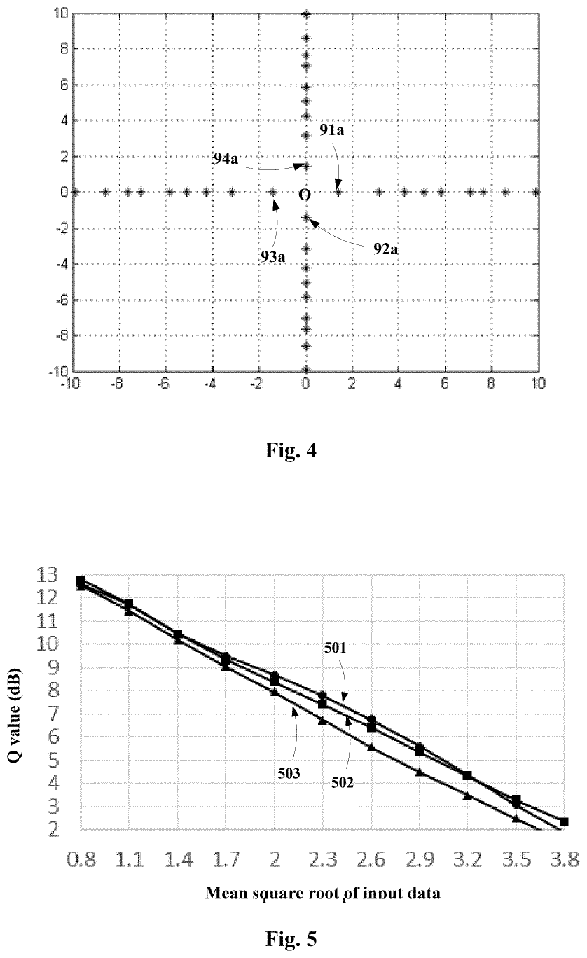

FIG. 4 is another schematic diagram of the constellation diagram of the pilot sequence of Implementation 1. As shown in FIG. 4, the pilot sequence may have 9 amplitude selections, which may be identical to the 9 amplitude selections shown in (B) of FIG. 2, respectively. Each amplitude selection corresponds to 4 constellation points; for example, constellation points 91a, 92a, 93a and 94a in FIG. 4 correspond to the same amplitude selection, and phases of the 4 constellation points 91a, 92a, 93a and 94a are such that the 4 constellation points 91a, 92a, 93a and 94a are rotationally symmetrical relative to the origin O of the constellation diagram by 90 degrees.

A difference between FIG. 4 and FIG. 3 exists in that for identical amplitude selections, the phases of the four constellation points in FIG. 4 are different from those of the four constellation points in FIG. 3. For example, the phases of the four constellation points 91a, 92a, 93a and 94a of FIG. 4 are different from the phases of the four constellation points 91, 92, 93 and 94 of FIG. 3.

FIG. 5 is a schematic diagram of a system Q value of a CMA scheme to which the pilot sequence of Implementation 1 corresponds. As shown in FIG. 5, a curve 501 corresponds to a target reference curve, a curve 502 corresponds to a curve obtained by using the pilot sequence in Implementation 1, and a curve 503 corresponds to a curve obtained by using a pilot sequence in existing techniques.

As shown in FIG. 5, the curve obtained by using the pilot sequence in Implementation 1 is closer to the target reference curve.

Implementation 2

In Implementation 2, the amplitude selection of the pilot sequence is identical to the amplitude selection of the payload, and phases of the constellation points to which each amplitude of the pilot sequence corresponds are randomly uniformly distributed. That is, the pilot sequence and the payload have identical amplitude probability characteristics.

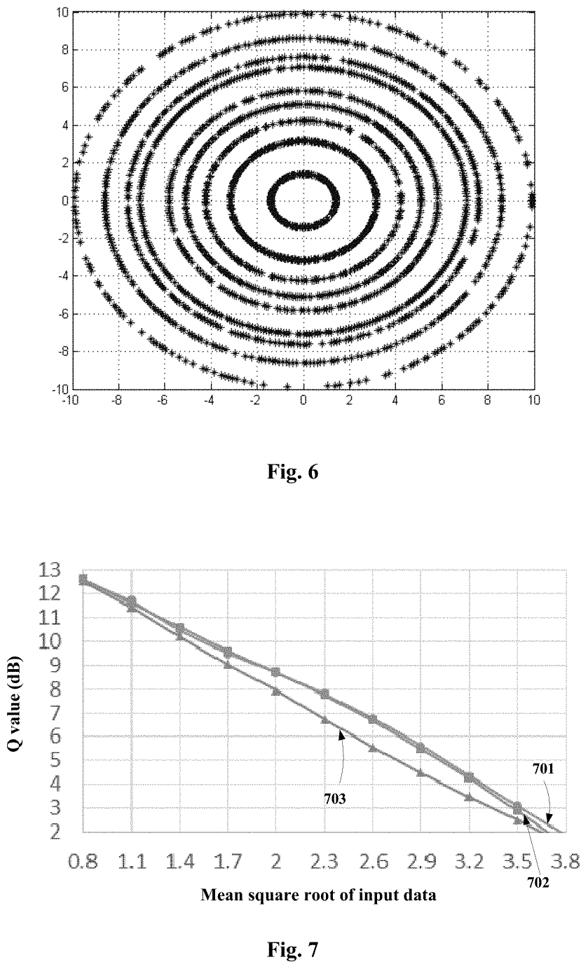

FIG. 6 is a schematic diagram of the constellation diagram of the pilot sequence of Implementation 2. As shown in FIG. 6, the pilot sequence may have 9 amplitude selections, which may be identical to the 9 amplitude selections shown in (B) of FIG. 2, respectively. The constellation points to which each amplitude selection corresponds are ring-shaped, representing that the phases of the constellation points to which the amplitude selection corresponds are randomly uniformly distributed.

FIG. 7 is a schematic diagram of a system Q value of a CMA scheme to which the pilot sequence of Implementation 2 corresponds. As shown in FIG. 7, a curve 701 corresponds to a target reference curve, a curve 702 corresponds to a curve obtained by using the pilot sequence in Implementation 2, and a curve 703 corresponds to a curve obtained by using a pilot sequence in existing techniques.

As shown in FIG. 7, the curve obtained by using the pilot sequence in Implementation 2 is closer to the target reference curve.

Implementation 3:

In Implementation 3, the amplitude selections of the pilot sequence are less than those of the payload, and constellation points of the amplitude selections of the pilot sequence coincide with the constellation points of the payload. For each amplitude selection of the pilot sequence, the amplitude selection corresponds to 4 constellation points, and phases of the 4 constellation points are such that the 4 constellation points are rotationally symmetric by 90 degrees relative to the origin of the constellation diagram. The pilot sequence has low-order origin moments identical to those of the payload, the low-order origin moments including origin moments starting from a first-order origin moment to an (n-1)-th-order origin moment; where, n is the number of amplitude selections of the pilot sequence. That is, the pilot sequence has an amplitude probability characteristic similar to that of the payload.

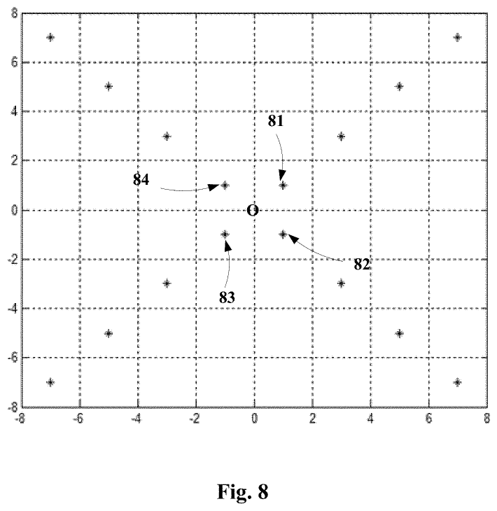

FIG. 8 is a schematic diagram of a constellation diagram of the pilot sequence of Implementation 3. As shown in FIG. 8, the number of amplitude selections of the pilot sequence is less than 9; for example, the number of the amplitude selections of the pilot sequence is 4 (i.e. n=4), and the amplitude selections of the pilot sequence are part of 9 amplitude selections shown in (B) of FIG. 2.

In FIG. 8, each amplitude selection of the pilot sequence corresponds to 4 constellation points. For example, constellation points 81, 82, 83 and 84 in FIG. 8 correspond to the same amplitude selection, and phases of the 4 constellation points 81, 82, 83 and 84 are such that the four constellation points 81, 82, 83 and 84 are rotationally symmetric by 90 degrees relative to the origin O of the constellation diagram.

In Implementation 3, the number of occurrences of constellation points of different amplitudes may be selected, so that the pilot sequence has low-order origin moments identical to those of the payload. For example, the low-order origin moments refer to origin moments starting from a first-order origin moment to an (n-1)-th-order origin moment; where, n is the number of amplitude selections of the pilot sequence, n=4 in FIG. 8. Therefore, low-order origin moments to which FIG. 8 corresponds include a first-order origin moment, a second-order origin moment and a third-order origin moment. For example, in FIG. 8, the first-order origin moment of the pilot sequence is equal to a first-order origin moment of the payload, the second-order origin moment of the pilot sequence is equal to a second-order origin moment of the payload, and the third-order origin moment of the pilot sequence is equal to a third-order origin moment of the payload.

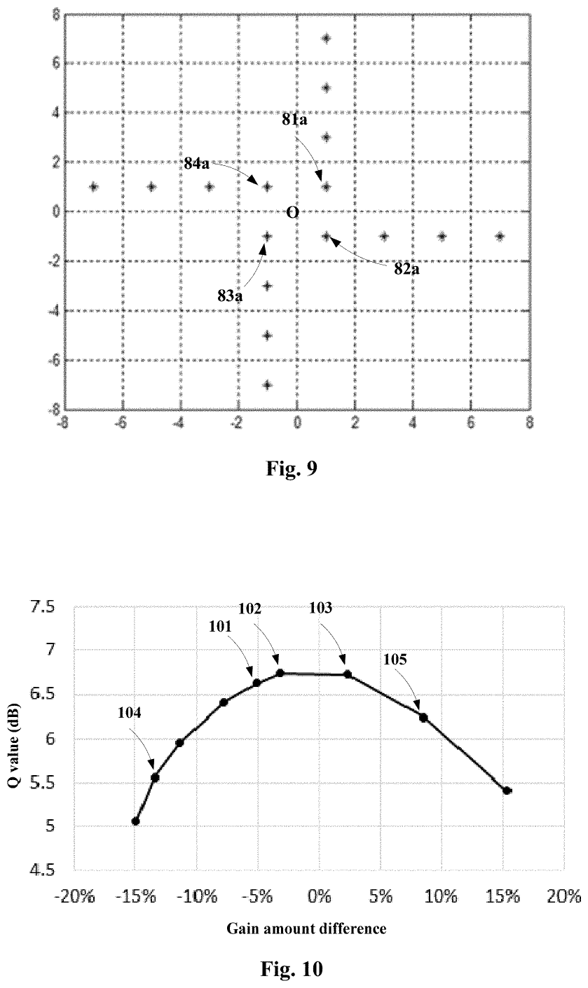

FIG. 9 is another schematic diagram of the constellation diagram of the pilot sequence of Implementation 3. As shown in FIG. 9, the pilot sequence has 4 amplitude selections, which may be part of the 9 amplitude selections shown in (B) of FIG. 2. Each amplitude selection corresponds to 4 constellation points, for example, constellation points 81a, 82a, 83a and 84a in FIG. 9 correspond to the same amplitude selection, and phases of the 4 constellation points 81a, 82a, 83a and 84a are such that the 4 constellation points 81a, 82a, 83a and 84a are rotationally symmetrical with respect to the origin O of the constellation diagram by 90 degrees.

Likewise, in FIG. 9, the low-order origin moments of the pilot sequence are identical to those of the payload, wherein low-order origin moments to which FIG. 9 corresponds include a first-order origin moment, a second-order origin moment and a third-order origin moment.

A difference between FIG. 9 and FIG. 8 exists in that for identical amplitude selections, phases of the constellation points of FIG. 9 are not exactly identical to the phases of the constellation points of FIG. 8.

Implementation 4:

In Implementation 4, a statistical distance may be used to represent identities or similarities of the amplitude probability characteristics.

Specifically, in Implementation 4, the statistical distance between the amplitude probability density function of the pilot sequence and the amplitude probability density function of the payload is less than a preset threshold. Thus, the pilot sequence and the payload may have similar amplitude probability characteristics. Moreover, when the statistical distance between the amplitude probability density function of the pilot sequence and the amplitude probability density function of the payload is equal to 0, it indicates that the pilot sequence and the payload have identical amplitude probability characteristics.

In Implementation 4, a method for calculating the statistical distance is that, for example: assuming that a probability density function of a random variable v is f(x) and a probability density function of a random variable u is g(x), a statistical distance between the probability density function f(x) and the probability density function g(x) may be calculated by using formula (1) as below:

0.5*∫|f(x)−g(x)|^{m}dx (1);

where, m is a preset constant, for example, m may be 1.

The amplitude selections of the pilot sequence are discrete random variables, and if a set of the amplitude selections of the pilot sequence and a set of the amplitude selections of the payload are identical (for example, the amplitude selections of the pilot sequence includes 9 values, which are respectively identical to values of the amplitude selections of the payload), formula (1) may be directly used to calculate the statistical distance between the amplitude probability density function of the pilot sequence and the amplitude probability density function of the payload. For example, f(x) in equation (1) may represent the amplitude probability density function of the pilot sequence, g(x) in equation (1) may represent the amplitude probability density function of the payload, and x represents the amplitude selections of the pilot sequence.

Furthermore, if the set of amplitude selections of the pilot sequence and the set of the amplitude selections of the payload are different, a resolution of the probability distribution may be lowered first and then the statistical distance may be calculated. Lowering the resolution of the probability distribution may be: in calculating the amplitude probability of the pilot sequence and the amplitude probability of the payload, mapping an amplitude selection to an amplitude selection interval to which the amplitude corresponds, and using the amplitude probability of the amplitude selection interval as the amplitude probability of the amplitude selection.

For example, in calculating an amplitude probability of x=x₀, amplitude probabilities of x₀−δ/2<x<x₀+δ/2 are all regarded as the amplitude probability of x=x₀, that is, mapping an amplitude selection x to an amplitude selection interval of (x₀−δ/2, x₀+δ/2), and an amplitude probability of this amplitude selection interval is taken as the amplitude probability of x=x₀. Where, δ is a preset resolution, which may take an amplitude interval of the payload.

Implementation 5:

In Implementation 5, identities or similarities of the probability characteristics may be represented by using an equidimensional distance between origin moment vectors.

Specifically, in Implementation 5, an equidimensional distance between an origin moment vector of the pilot sequence and an origin moment vector of the payload is less than a preset threshold. Thus, the pilot sequence and the payload may have similar amplitude probability characteristics. Moreover, when the equidimensional distance between the origin moment vector of the pilot sequence and the origin moment vector of the payload is 0, it indicates that the pilot sequence and the payload have identical amplitude probability characteristics.

The origin moment vector is a vector formed by origin moments from a first-order origin moment to an (n-1)-th-order origin moment; where, n is the number of the amplitude selections of the pilot sequence.

In Implementation 5, assuming that a first-order origin moment of the random variable v is v₁, and a second-order origin moment thereof is v₂, . . . , the origin moment vector of the random variable v is [v₁ v₂ v₃ . . . ], and assuming that a first-order origin moment of the random variable u is u₁, and a second-order origin moment thereof is u₂, . . . , the origin moment vector of the random variable u is [u₁ u₂ u₃ . . . ].

An equidimensional distance between the origin moment vector of the random variable v and the origin moment vector of the random variable u is expressed as formula (2) below:

$$\frac{\sum ( {\vert {v}_{1} - {u}_{1} \vert}^{n / 1} + {\vert {v}_{2} - {u}_{2} \vert}^{n / 2} + {\vert {v}_{3} - {u}_{3} \vert}^{n / 3} + … )}{\sqrt{\sum ( {\vert {v}_{1} \vert}^{n / 1} + {\vert {v}_{2} \vert}^{n / 2} + {\vert {v}_{3} \vert}^{n / 3} + … )} \cdot \sqrt{\sum ( {\vert {u}_{1} \vert}^{n / 1} + {\vert {u}_{2} \vert}^{n / 2} + {\vert {u}_{3} \vert}^{n / 3} + … )}} . \qquad ( 2 )$$

In formula (2), powers of origin moments of different orders are different, indicating an equidimensional operation. Summation may be truncated to an order n-1. And n is the number of amplitude selections of the pilot sequence.

In applying formula (2) to calculate the equidimensional distance between the origin moment vector of the pilot sequence and the origin moment vector of the payload, the random variable v may be an amplitude selection of the pilot sequence, and the random variable u may be an amplitude selection of the payload.

In a variant of this embodiment, the pilot sequence and the payload may not be required to have identical or similar amplitude probability characteristics. For example, in this variant, a pilot sequence with a single amplitude selection may be used.

In this variant, a ratio of a difference between a gain amount of the pilot sequence and a gain amount of the payload transmitted by the signal generation device 11 to the gain amount of the payload may be less than a preset value, for example, it satisfies a condition of formula (3) below:

$$\frac{\vert {G}_{pilot} - {G}_{payload} \vert}{{G}_{payload}} < preset value \qquad ( 3 )$$

where, G denotes the gain amount; for example: Gₚᵢₗₒₜ and G_{payload} denote the gain amount of the pilot sequence and the gain amount of the payload, respectively.

In this disclosure, the gain amount G refers to a ratio of average power after passing through a nonlinear system to average power not passing through the nonlinear system. Usually, the gain amount G is in unit of dB.

Taking that the payload are of 64 QAM as an example, FIG. 10 is a diagram of a relationship between a gain amount difference and a system Q value in a single amplitude pilot sequence scheme. An equalization method used is CMA. The preset value may be a gain amount difference to which a drop of 0.3 dB in an optimal Q value corresponds, such as a gain amount difference (that is, a value of a horizontal ordinate) to which three points 101, 102 and 103 with a largest Q value in FIG. 10 correspond, so as to achieve optimal performance.

In existing techniques, it is not required that the pilot sequence of single amplitude satisfies the above formula (3). System Q values to which the pilot sequence corresponds are a Q value to which a second point 104 from the left in FIG. 10 (that is, with a QPSK amplitude that is an amplitude to which average power of the transmitted data corresponds) corresponds and a Q value to which a second point 105 from the right in FIG. 10 (that is, with a QPSK amplitude that is a largest amplitude on the constellation diagram of the payload) corresponds.

In this disclosure, the equalization processing device 22 may perform adaptive equalization processing by using the pilot sequence and payload generated by the signal generation device 11 in embodiment 1 or the variant of embodiment 1, such as replacing a pilot sequence used in adaptive equalization processing in related techniques with the pilot sequence described in embodiment 1 or the variant of embodiment 1 in this disclosure.

According to embodiment 1 of this disclosure, the pilot sequence and the payload generated by the signal generation device have identical or similar amplitude probability characteristics. Therefore, it is ensured that adaptive equalization performed based on the pilot sequence may also be applied to the transmitting data (payloads) under nonlinear conditions, and no nonlinear cost will be introduced. In addition, in the variant of embodiment 1, the ratio of a difference between a gain amount of the pilot sequence and a gain amount of the payload transmitted by the signal generation device 11 to the gain amount of the payload may be smaller than the preset value.

Applying the pilot sequence in embodiment 1 and its variant may make the adaptive equalization resistant to influence of a nonlinear effect. The scheme may be applicable to a variety of modulation formats, and does not need to introduce additional devices and equipments, nor to change a digital signal processing (DSP) algorithm framework structure of an existing transmitter and receiver.

### Embodiment 2

Embodiment 2 provides a signal generation method. As a principle of this method for solving problems is similar to that of the signal generation device in Embodiment 1, reference may be made to the implementation in Embodiment 1 for implementation thereof, with identical contents being not going to be repeated herein any further.

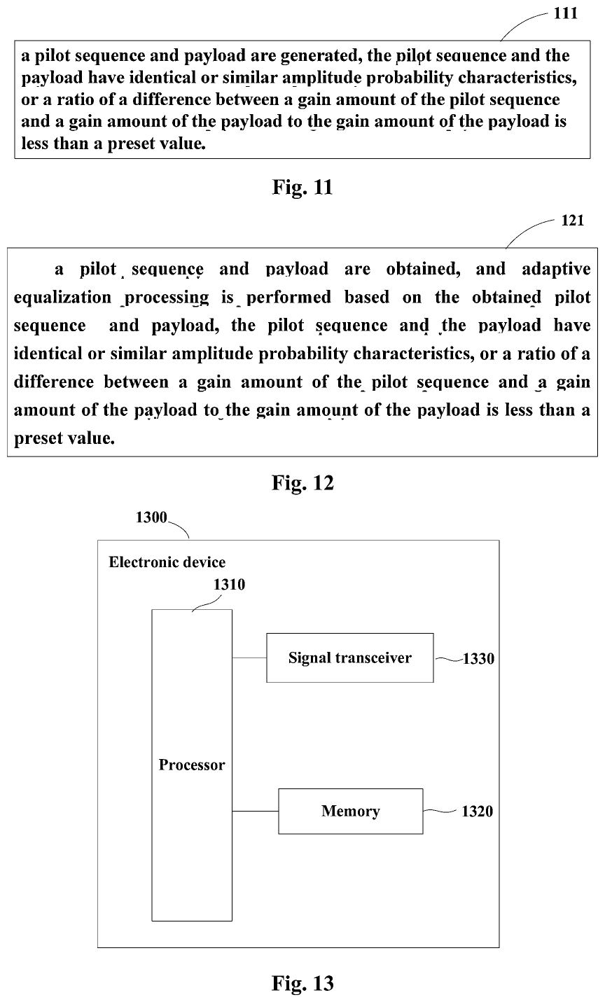

FIG. 11 is a schematic diagram of the signal generation method in this embodiment. As shown in FIG. 11, the signal generation method includes:

operation 111: a pilot sequence and payload are generated, the pilot sequence and the payload have identical or similar amplitude probability characteristics, or a ratio of a difference between a gain amount of the pilot sequence and a gain amount of the payload to the gain amount of the payload is less than a preset value.

Embodiment 2 further provides a signal receiving method. As a principle of this method for solving problems is similar to that of the equalization processing device in Embodiment 1, reference may be made to the implementations in Embodiment 1 for implementations thereof, with identical contents being not going to be repeated herein any further.

FIG. 12 is a schematic diagram of the equalization processing method in this embodiment. As shown in FIG. 12, the equalization processing method includes:

operation 121: a pilot sequence and payload are obtained, and adaptive equalization processing is performed based on the obtained pilot sequence and payload, the pilot sequence and the payload have identical or similar amplitude probability characteristics, or a ratio of a difference between a gain amount of the pilot sequence and a gain amount of the payload to the gain amount of the payload is less than a preset value.

According to Embodiment 2 of this disclosure, applying the pilot sequence in Embodiment 2 may make the adaptive equalization resistant to influence of a nonlinear effect. The scheme may be applicable to a variety of modulation formats, and does not need to introduce additional devices and equipments, nor to change a digital signal processing (DSP) algorithm framework structure of an existing transmitter and receiver.

Embodiment 3

The embodiment of this disclosure provides an electronic device. FIG. 13 is a schematic diagram of a structure of the electronic device. As shown in FIG. 13, the electronic device 1300 includes a processor (such as a digital signal processor (DSP)) 1310 and a memory 1320, the memory 1320 being coupled to the processor 1310. The memory 1320 may store various data, and furthermore, it may store a program for information processing, and execute the program under control of the processor 1310. The electronic device 1300 may further include a signal transmitter 1330. The electronic device 1300 may implement functions of the signal generation device 11 or the equalization processing device 22.

In one implementation, the functions of the signal generation device 11 or the equalization processing device 22 may be integrated into the processor 1310. The processor 1310 may be configured to carry out the signal generation method or the equalization processing method described in Embodiment 2.

In another implementation, the realization signal generation device 11 or the equalization processing device 22 may be configured separately from the processor 1310. For example, the signal generation device 11 or the equalization processing device 22 may be configured as a chip connected to the processor 1310, and the functions of the signal generation device 11 or the equalization processing device 22 are executed under control of the processor 1310.

It should be noted that the electronic device 1300 does not necessarily include all the components shown in FIG. 13; and furthermore, the electronic device 1300 may include components not shown in FIG. 13, and reference may be made to the related art.

In this disclosure, the electronic device 1300 may implement the functions of the transmitter 10 shown in FIG. 1.

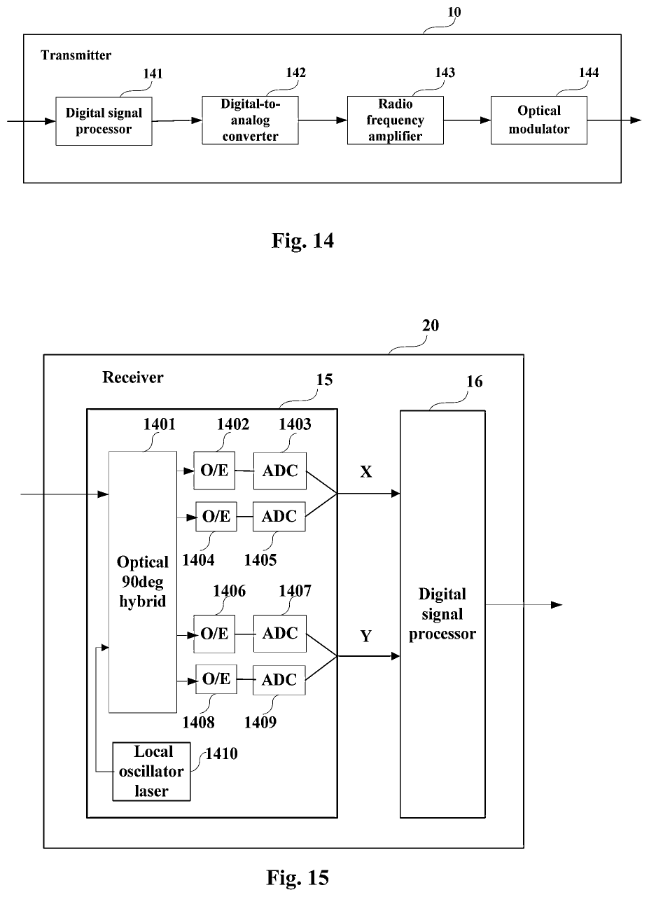

FIG. 14 is a block diagram of a systematic structure of a transmitter of Embodiment 3 of this disclosure. As shown in FIG. 14, the transmitter 10 includes: a digital signal processor 141, a digital-to-analog converter 142, a radio frequency amplifier 143 and an optical modulator 144.

The digital signal processor 141 may execute the functions of the signal generation device 11, that is, generating a pilot sequence and transmitting data (payloads). And furthermore, the digital signal processor 141 may perform such processing as signal encoding, pulse shaping, pre-compensation, and quantization.

The digital-to-analog converter 142, the radio frequency amplifier 143 and the optical modulator 144 may execute functions of the first processing device 11. The digital-to-analog converter 142 performs digital-to-analog conversion on a digital signal outputted by the digital signal processor 141 to obtain an analog signal; the radio frequency amplifier 143 amplifies the analog signal; and the optical modulator 144 modulates the signal to generate an optical signal for transmission. The transmitter 10 may not include the optical modulator 144 if a transmitted signal is not an optical signal, but a radio frequency signal.

In this disclosure, the electronic device 1300 may also execute the functions of the receiver 20 shown in FIG. 1.

FIG. 15 is a block diagram of a systematic structure of the receiver of Embodiment 3 of this disclosure. The receiver is, for example, an optical receiver. As shown in FIG. 15, the receiver 20 includes:

a front end 15 and a digital signal processor 16. The front end 15 is configured to convert an input optical signal into baseband signals in two polarization states. And the front end 15 may execute function of a second processing device 21.

As shown in FIG. 15, the front end 15 includes: a local oscillator laser 1410, an optical 90 deg hybrid 1401, opto-electronic (O/E) detectors 1402, 1404, 1406 and 1408, and analog-to-digital converters (ADCs) 1403, 1405, 1407 and 1409.

The local oscillator laser 1410 is configured to provide a local light source; an optical signal is converted into a baseband signal in a polarization state after passing through the optical 90 deg hybrid 1401 and the analog-to-digital converters (ADCs) 1403 and 1405; and the optical signal is converted into a baseband signal in another polarization state after passing through the optical 90 deg hybrid 1401, the opto-electronic (O/E) 1406 and 1408 and the analog-to-digital converters (ADCs) 1407 and 1409, with a detailed process being similar to that in the related art, and being not going to be described herein any further. Furthermore, for a radio frequency signal, the front end 15 may not include the local oscillator laser 1410, the optical 90 deg hybrid 1401 and the opto-electronic (O/E) detectors 1402, 1404, 1406 and 1408.

The digital signal processor 16 may execute the functions of the equalization processing device 22, i.e. performing adaptive equalization processing. And furthermore, the digital signal processor 16 may perform the following processing: re-sampling, clock compensation, disperse compensation (needed for an optical signal, and is not needed for a radio frequency signal), carrier phase recovery (needed for an optical signal, and is not needed for a radio frequency signal), and transmitter nonideality compensation, etc.

An embodiment of the present disclosure provides a computer readable program, which, when executed in a signal generation device or an equalization processing device, will cause a computer to carry out the signal generation method or the equalization processing method as described in Embodiment 2.

An embodiment of the present disclosure provides a computer storage medium, including a computer readable program, which will cause a computer to carry out the signal generation method or the equalization processing method as described in Embodiment 2.

The signal generation method or the equalization processing method described with reference to the embodiments of this disclosure may be directly embodied as hardware, software modules executed by a processor, or a combination thereof. For example, one or more functional block diagrams and/or one or more combinations of the functional block diagrams shown in the drawings may either correspond to software modules of procedures of a computer program, or correspond to hardware modules. Such software modules may respectively correspond to the steps shown in the drawings. And the hardware module, for example, may be carried out by firming the soft modules by using a field programmable gate array (FPGA).

The soft modules may be located in an RAM, a flash memory, an ROM, an EPROM, and EEPROM, a register, a hard disc, a floppy disc, a CD-ROM, or any memory medium in other forms known in the art. A memory medium may be coupled to a processor, so that the processor may be able to read information from the memory medium, and write information into the memory medium; or the memory medium may be a component of the processor. The processor and the memory medium may be located in an ASIC. The soft modules may be stored in a memory of a mobile terminal, and may also be stored in a memory card of a pluggable mobile terminal. For example, if equipment (such as a mobile terminal) employs an MEGA-SIM card of a relatively large capacity or a flash memory device of a large capacity, the soft modules may be stored in the MEGA-SIM card or the flash memory device of a large capacity.

One or more functional blocks and/or one or more combinations of the functional blocks in FIGS. 4-9 may be realized as a universal processor, a digital signal processor (DSP), an application-specific integrated circuit (ASIC), a field programmable gate array (FPGA) or other programmable logic devices, discrete gate or transistor logic devices, discrete hardware component or any appropriate combinations thereof carrying out the functions described in this application. And the one or more functional block diagrams and/or one or more combinations of the functional block diagrams in FIGS. 4-9 may also be realized as a combination of computing equipment, such as a combination of a DSP and a microprocessor, multiple processors, one or more microprocessors in communication combination with a DSP, or any other such configuration.

This disclosure is described above with reference to particular embodiments. However, it should be understood by those skilled in the art that such a description is illustrative only, and not intended to limit the protection scope of the present disclosure. Various variants and modifications may be made by those skilled in the art according to the principle of the present disclosure, and such variants and modifications fall within the scope of the present disclosure.

For implementations of this disclosure containing the above embodiments, following example supplements are further disclosed.

In an example, a signal generation device, may be generating a pilot sequence and payloads, wherein, the pilot sequence and the payload have identical or similar amplitude probability characteristics.

In an example, amplitude selections of the pilot sequence are identical to amplitude selections of the payload, and each amplitude selection of the pilot sequence corresponds to 4 constellation points, phases of the 4 constellation points making the 4 constellation points 90-degrees rotationally symmetrical relative to the origin of a constellation diagram.

In an example, amplitude selections of the pilot sequence are identical to amplitude selections of the payload, and phases of the constellation points of the pilot sequence are randomly uniformly distributed.

In an example, for each amplitude selection of the pilot sequence, each amplitude selection corresponds to 4 constellation points, phases of the 4 constellation points making the 4 constellation points 90-degree rotationally symmetrical relative to the origin of the constellation diagram, constellation points of the amplitude selections of the pilot sequence coincide with the constellation points of the payload, the pilot sequence has the same low-order origin moment as the payload, the low-order origin moment including starting from a first-order origin moment to an (n-1)-th-order origin moment, where, n is the number of the amplitude selections of the pilot sequence.

In an example, a statistical distance between an amplitude probability density function of the pilot sequence and an amplitude probability density function of the payload is less than a preset threshold.

In an example, in a case where a set of the amplitude selections of the pilot sequence is different from a set of amplitude selections of the payload, in calculating an amplitude probability of the pilot sequence and an amplitude probability of the payload, each amplitude selection is mapped to an amplitude selection interval corresponding to the amplitude selection, and an amplitude probability of the amplitude selection interval is taken as the amplitude probability of the amplitude selection.

In an example, an equidimensional distance between an origin moment vector of the pilot sequence and an origin moment vector of the payload is less than a preset threshold, the origin moment vectors being vectors constituted from a first-order origin moment to an (n-1)-th-order origin moment; where, n is the number of amplitude selections of the pilot sequence.

In an example, a signal generation device, may be generating a pilot sequence and payloads, wherein, a ratio of a difference between a gain amount of the pilot sequence and a gain amount of the payload to the gain amount of the payload is less than a preset value.

In an example, an equalization processing device, may be performing adaptive equalization processing based on a pilot sequence and payloads, wherein, the pilot sequence and the payload have identical or similar amplitude probability characteristics, or a ratio of a difference between a gain amount of the pilot sequence and a gain amount of the payload to the gain amount of the payload is less than a preset value.

In an example, an electronic device, may include the signal generation device as described above, or include the equalization processing device as described above.

In an example, a signal generation method may include generating a pilot sequence and payloads, wherein, the pilot sequence and the payload have identical or similar amplitude probability characteristics.

In an example, amplitude selections of the pilot sequence are identical to amplitude selections of the payload, and each amplitude selection of the pilot sequence corresponds to 4 constellation points, phases of the 4 constellation points making the 4 constellation points 90-degrees rotationally symmetrical relative to the origin of a constellation diagram.

In an example, amplitude selections of the pilot sequence are identical to amplitude selections of the payload, and phases of the constellation points of the pilot sequence are randomly uniformly distributed.

In an example, for each amplitude selection of the pilot sequence, each amplitude selection corresponds to 4 constellation points, phases of the 4 constellation points making the 4 constellation points 90-degree rotationally symmetrical relative to the origin of the constellation diagram, constellation points of the amplitude selections of the pilot sequence coincide with the constellation points of the payload, the pilot sequence has the same low-order origin moment as the payload, the low-order origin moment including starting from a first-order origin moment to an (n-1)-th-order origin moment, where, n is the number of the amplitude selections of the pilot sequence.

In an example, a statistical distance between an amplitude probability density function of the pilot sequence and an amplitude probability density function of the payload is less than a preset threshold.

In an example, in a case where a set of the amplitude selections of the pilot sequence is different from a set of amplitude selections of the payload, in calculating an amplitude probability of the pilot sequence and an amplitude probability of the payload, each amplitude selection is mapped to an amplitude selection interval corresponding to the amplitude selection, and an amplitude probability of the amplitude selection interval is taken as the amplitude probability of the amplitude selection.

In an example, an equidimensional distance between an origin moment vector of the pilot sequence and an origin moment vector of the payload is less than a preset threshold, the origin moment vectors being vectors constituted from a first-order origin moment to an (n-1)-th-order origin moment; where, n is the number of amplitude selections of the pilot sequence.

In an example, a signal generation method may include generating a pilot sequence and payloads, wherein, a ratio of a difference between a gain amount of the pilot sequence and a gain amount of the payload to the gain amount of the payload is less than a preset value.

In an example, an equalization processing method may include performing adaptive equalization processing based on an obtained pilot sequence and payload, wherein the pilot sequence and the payload have identical or similar amplitude probability characteristics, or a ratio of a difference between a gain amount of the pilot sequence and a gain amount of the payload to the gain amount of the payload is less than a preset value.

1. A signal generation device, comprising:
a memory; and
a processor coupled to the memory, the processor to control execution of a process including,
generating a pilot sequence signal; and
generating a payload,
wherein,
the pilot sequence signal and the payload have identical or similar amplitude probability characteristics.

2. The signal generation device according to claim 1, wherein,
amplitude selections of the pilot sequence signal are identical to amplitude selections of the payload, and an amplitude selection, among the amplitude selections, of the pilot sequence signal corresponds to 4 constellation points, phases of the 4 constellation points making the 4 constellation points 90-degrees rotationally symmetrical relative to an origin of a constellation diagram.

3. The signal generation device according to claim 1, wherein,
amplitude selections of the pilot sequence signal are identical to amplitude selections of the payload, and phases of constellation points of the pilot sequence signal are randomly uniformly distributed.

4. The signal generation device according to claim 1, wherein,
for an amplitude selection of the pilot sequence signal, the amplitude selection corresponds to 4 constellation points, phases of the 4 constellation points making the 4 constellation points 90-degree rotationally symmetrical relative to an origin of the constellation diagram,
constellation points of the amplitude selection of the pilot sequence signal coincides with the constellation points of the payload,
the pilot sequence signal has a same low-order origin moment as the payload,
the low-order origin moment including starting from a first-order origin moment to an (n-1)th-order origin moment,
where, n is a number of amplitude selections of the pilot sequence signal.

5. The signal generation device according to claim 1, wherein,
a statistical distance between an amplitude probability density function of the pilot sequence signal and an amplitude probability density function of the payload is less than a threshold.

6. The signal generation device according to claim 5, wherein,
in a case where a set of amplitude selections of the pilot sequence signals is different from a set of amplitude selections of the payloads, in calculating an amplitude probability of the pilot sequence signal and an amplitude probability of the payload, an amplitude selection, among the amplitude selections, is mapped to an amplitude selection interval corresponding to the amplitude selection, and an amplitude probability of the amplitude selection interval is taken as the amplitude probability of the amplitude selection.

7. The signal generation device according to claim 1, wherein,
an equidimensional distance between an origin moment vector of the pilot sequence signal and an origin moment vector of the payload is less than a set threshold, the origin moment vectors being vectors constituted from a first-order origin moment to an (n-1)th-order origin moment; where, n is a number of amplitude selections of the pilot sequence signal.

8. A signal generation device, comprising:
a memory; and
a processor coupled to the memory, the processor to control execution of a process including,
generating a pilot sequence signal; and
generating a payload, wherein,
a ratio of a difference between a gain amount of the pilot sequence signal and a gain amount of the payload, to the gain amount of the payload is less than a set value.

9. An equalization processing device, comprising:
a memory; and
a processor coupled to the memory, the processor to control execution of a process including,
performing adaptive equalization processing based on a pilot sequence signal and a payload,
wherein,
the pilot sequence signal and the payload have identical or similar amplitude probability characteristics, or a ratio of a difference between a gain amount of the pilot sequence signal and a gain amount of the payload, to the gain amount of the payload is less than a set value.
